(19) United States
(12) Patent Application Publication
(10) Pub. No.: US 2014/0250600 A1
(43) Pub. Date: Sep. 11, 2014

(54) ELECTRIC FOLDING BED

(71) Applicants: RUOEY LUNG ENTERPRISE CORP., Lu-Kang Town (TW); PPJ. LLC, Natick, MA (US)

(72) Inventors: Philip Woods MCCARTY, Natick, MA (US); Philip Reid SHERMAN, Melville, NY (US); Chuan-Hang SHIH, Lu-Kang Town (TW)

(73) Assignees: PPJ. LLC, Natick, MA (US); RUOEY LUNG ENTERPRISE CORP., Lu-Kang Town (TW)

(21) Appl. No.: 13/785,399

(22) Filed: Mar. 5, 2013

(51) Int. Cl. A61G 7/015

(52) U.S. Cl. CPC A61G 7/015
USPC 5/617

(57) ABSTRACT

An electric folding bed includes a base having a load-bearing element for supporting hips of a user and at least a track extending along a head-to-foot axis of the bed, a telescopic actuator having a body pivotally attached to the base and a telescoping element linearly moveable relative to the body along the head-to-foot axis substantially, a connecting unit pivotally connected with the telescoping element, a backboard fastened to the connecting unit for the user to lean thereon, at least a supporting element pivotally attached to the base and the connecting unit, and at least a moving element disposed to the track and pivotally attached to the connecting unit. The telescoping element drives the connecting unit and the backboard to swing up and displace away from the load-bearing element. Therefore, the electric folding bed can avoid user's uncomfort and injury when the user sits up.

### BACKGROUND OF THE INVENTION

1. Field of the Invention

The present invention relates generally to a folding bed which allows a user to lie flat thereon and has a backboard capable of swinging up so that the user can sit up and lean against the backboard. The present invention relates more particularly to an electric folding bed which has a backboard capable of swinging and displacing at the same time.

2. Description of the Related Art

The conventional electric folding bed primarily comprises a stationary base, a backboard pivotally attached to the base, and an actuator for driving the backboard to swing relative to the base. Through the actuation of the actuator, the backboard can be set at a posture that is flush with the base so that the user can lie flat on the base and the backboard; in addition, the backboard can be driven to swing up from aforesaid posture so that the user can sit up with his back leaning against the backboard.

However, when the user sits up from the lying flat posture, the abdomen of the user, especially a fat user, is liable to be pressed; at this circumstance, the only way for the user to find a comfortable posture is to move the user's hips by himself. But, for the users unable to move freely, the aforesaid movement of the hips may be unachievable or cause the user's injury.

### SUMMARY OF THE INVENTION

The present invention has been accomplished in view of the above-noted circumstances. It is an objective of the present invention to provide an electric folding bed which has a backboard capable of swinging up and displacing backward at the same time so as to avoid causing the user's uncomfort and injury.

To attain the above objective, the present invention provides an electric folding bed, which is defined with an imaginary head-to-foot axis, comprising a base, a telescopic actuator, a connecting unit, a backboard, at least a supporting element, and at least a moving element. The base comprises a load-bearing element for supporting hips of a user and at least a track extending along the head-to-foot axis of the electric folding bed. The telescopic actuator comprises a body pivotally attached to the base and a telescoping element linearly moveable relative to the body substantially along the head-to-foot axis of the electric folding bed. The backboard is fastened to the connecting unit for the user to lean thereon and has a first end facing the load-bearing element and a second end opposite to the first end. The connecting unit is pivotally connected with the telescoping element in a way that the telescoping element drives the connecting unit to swing between a first position and a second position and the second end of the backboard will be lifted up when the connecting unit swings from the first position to the second position. The supporting element has a front end and a rear end located more adjacent to the first end of the backboard than the front end. The front end and the rear end of the supporting element are pivotally attached to the base and the connecting unit respectively. The moving element is disposed to the track of the base and pivotally attached to the connecting unit in a way that the connecting unit swings about the moving element and drives the moving element to move along the track of the base and the moving element will move away from the load-bearing element when the connecting unit swings from the first position to the second position.

As a result, the backboard can be lifted up to enable the user to sit up from the lying flat posture and lean against the backboard. Besides, in the aforesaid lifting up process, the backboard will displace away from the back of the user a little along with the connecting unit. Therefore, the electric folding bed can avoid the abdomen of the user from being pressed when the user sits up so as to avoid the user's uncomfort and injury.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of an electric folding bed provided by a preferred embodiment of the present invention and showing a status that a user can lie flat on the electric folding bed;

FIG. 2 is similar to FIG. 1, but wherein a load-bearing element and a backboard are not shown for the convenience of illustration;

FIG. 3 is a bottom view of the electric folding bed in the same status with that shown in FIG. 1;

FIG. 4 is a sectional view of the electric folding bed in the same status with that shown in FIG. 1;

FIG. 5 is a perspective view of the electric folding bed provided by the preferred embodiment of the present invention and showing another status that the user can sit and lean against the backboard of the electric folding bed; and

FIG. 6 is a sectional view of the electric folding bed in the same status with that shown in FIG. 5.

### DETAILED DESCRIPTION OF THE INVENTION

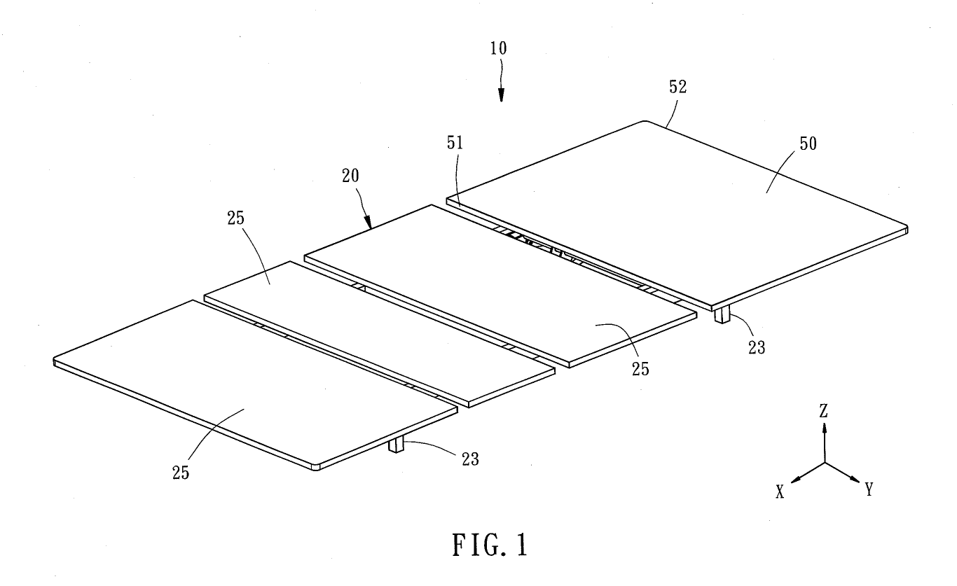

Referring to FIGS. 1-6, an electric folding bed 10, which is provided by a preferred embodiment of the present invention, comprises a base 20, a telescopic actuator 30, a connecting unit 40, a backboard 50, two moving elements 60, and two supporting elements 70.

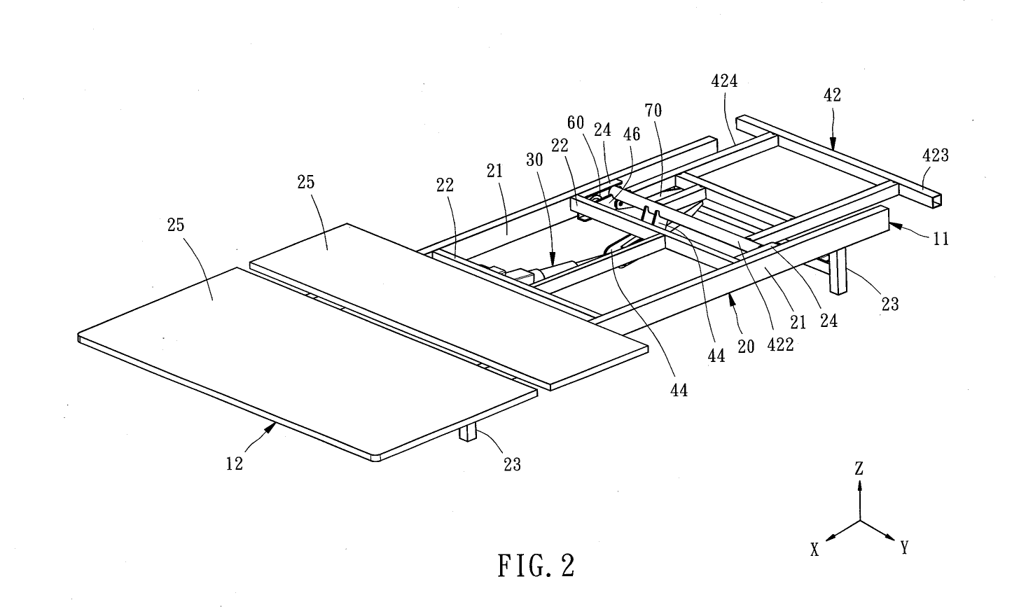

As shown in FIGS. 1-3, the base 20 primarily comprises two lengthwise beams 21, two widthwise beams 22 fixedly connected between the lengthwise beams 21, two H-shaped stands 23 fixedly connected between the lengthwise beams 21 for standing on the floor, two tracks 24 mounted to inner sides of the lengthwise beams 21 respectively, and three tabulate load-bearing elements 25 fastened on the lengthwise beams 21 and the widthwise beams 22. The load-bearing elements 25 are adapted for supporting hips of a user or legs of the user. As shown in FIG. 2, the electric folding bed 10 is defined with a head portion 11, a foot portion 12, and an imaginary head-to-foot axis such as the x-axis in FIGS. 1-2 and FIG. 5. Under normal usage, the hips and the legs of the user are located on the load-bearing elements 25 and the soles of the user face the foot portion 12 of the electric folding bed 10, i.e. toward positive direction of x-axis. The tracks 24 extend along the head-to-foot axis of the electric folding bed 10.

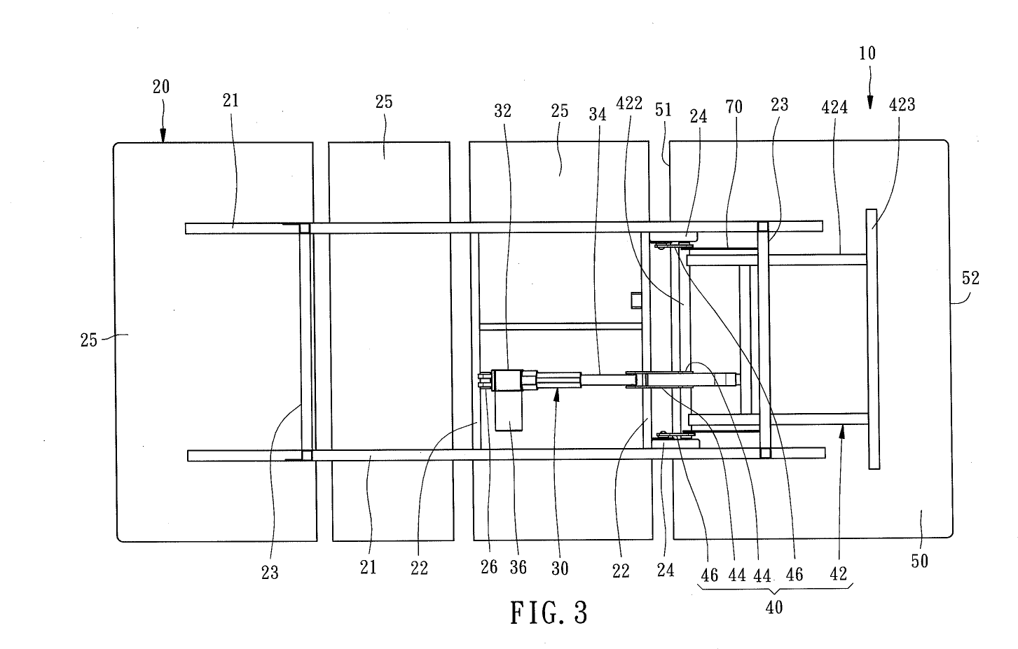

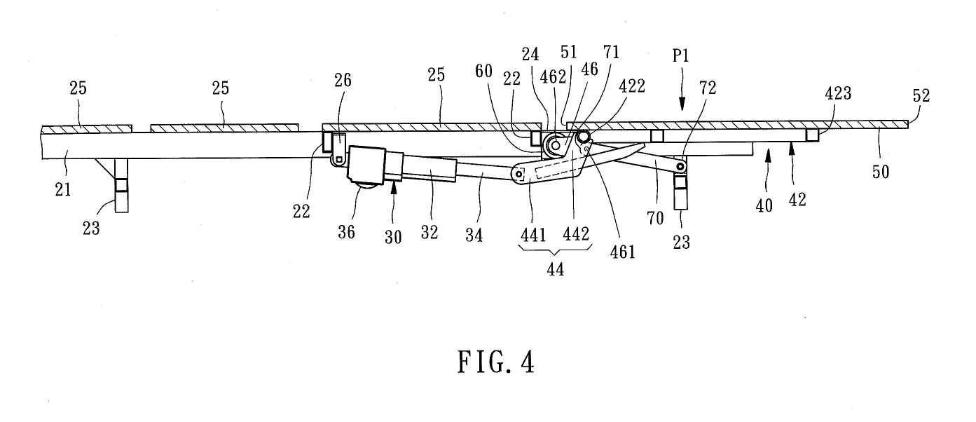

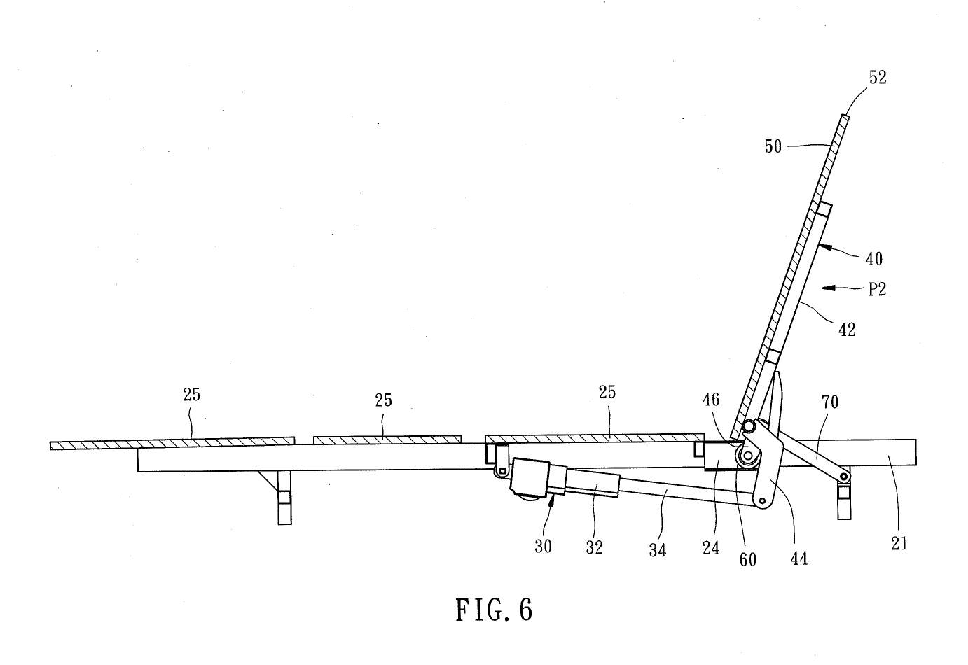

The telescopic actuator 30 is an electro-mechanical linear actuator which is driven by a motor in this embodiment, but also can be other kinds of linear actuator, such as hydraulic actuators and pneumatic actuators. As shown in FIGS. 3-4, the telescopic actuator 30 comprises a body 32, a telescoping element 34 with an end inserted into the body 32, and a motor 36 mounted to the body 32 for driving the telescoping element 34 to move linearly relative to the body 32. An end of the body 32 is pivotally attached to a connecting piece 26 fixed at one of the widthwise beams 22 of the base 20. The tracks 24 of the base 20 are located by two sides of the telescopic actuator 30 respectively. The telescoping element 34 extends from the body 32 toward the head portion 11 and is linearly moveable relative to the body 32 along the head-to-foot axis of the electric folding bed 10 substantially. Because the body 32 is pivotable relative to the base 20, the telescoping element 34 might not move absolutely along the head-to-foot axis, but a little slantwise upwards or downwards; for example, the telescoping element 34 moves slantwise downwards from the position shown in FIG. 4 to the position shown in FIG. 6. It will be appreciated that the phrase “the telescoping element 34 is linearly moveable relative to the body 32 along the head-to-foot axis substantially” mentioned in the invention refers to that the telescoping element 34 basically moves toward the head portion 11 or the foot portion 12 of the electric folding bed 10, but not limited to move absolutely along the head-to-foot axis.

As shown in FIG. 3, the connecting unit 40 comprises a frame 42, two first connecting elements 44, and two second connecting elements 46. The frame 42, which is fastened to the backboard 50, primarily comprises two widthwise rods 422, 423 and an H-shaped support 424 fixedly connected between the widthwise rods 422, 423. As shown in FIG. 4, each first connecting element 44 has a first part 441 and a second part 442 integrally connected with the first part 441 at a predetermined angle so that the first connecting element 44 has a curved shape like elbow. An end of the first part 441 of each first connecting element 44 is pivotally connected with the telescoping element 34. An end of the second part 442 of each first connecting element 44 is fastened to the widthwise rod 422 and located between the first part 441 of the first connecting element 44 and the backboard 50. As shown in FIG. 3, the second connecting elements 46 are fastened to two ends of the widthwise rod 422 respectively. The backboard 50 has a first end 51 facing the load-bearing elements 25 and a second end 52 opposite to the first end 51.

Each moving element 60 is a wheel in this embodiment, but also can be a sliding block. The moving elements 60 are pivotally attached to the second connecting elements 46 respectively and disposed to the tracks 24 respectively.

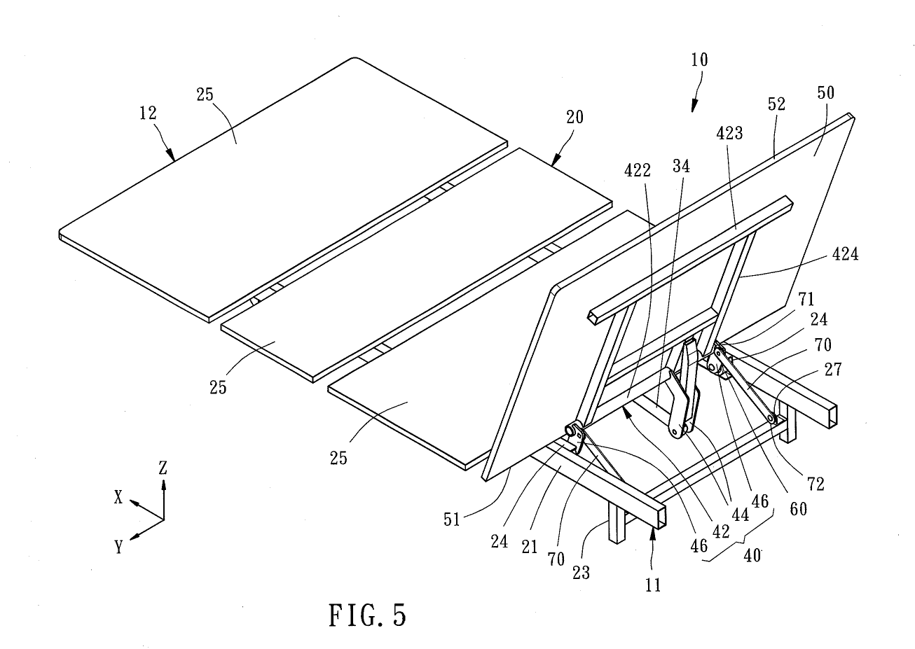

As shown in FIGS. 4-5, each supporting element 70 has a rear end 71 and a front end 72. The rear ends 71 of the supporting elements 70 are pivotally attached to the second connecting elements 46 respectively. The front ends 72 of the supporting elements 70 are pivotally attached to two connecting pieces 27 fixed at one of the stands 23 of the base 20 respectively, as shown in FIG. 5. In each supporting element 70, the rear end 71 is located more adjacent to the first end 51 of the backboard 50 than the front end 72. As shown in FIG. 4, each second connecting element 46 has a first connecting portion 461 pivotally connected with one of the supporting elements 70, and a second connecting portion 462 pivotally connected with one of the moving elements 60. In each assemblage of one said second connecting element 46 and one said supporting element 70, the first connecting portion 461 of the second connecting element 46 is located between the second connecting portion 462 of the second connecting element 46 and the front end 72 of the supporting element 70, as shown in FIG. 4.

As a result, the base 20, the body 32 and the telescoping element 34 of the telescopic actuator 30, the connecting unit 40, the combination of the moving elements 60, and the combination of the supporting elements 70 are able to be considered as six members of a planar six-bar mechanism with one degree of freedom. When the telescoping element 34 moves linearly, the connecting unit 40 will swing and displace correspondingly.

Specifically speaking, when the connecting unit 40 is located at a first position P1 shown in FIG. 4, the backboard 50 is flush with the load-bearing elements 25 so that the user can lie flat on the load-bearing elements 25 and the backboard 50; at this stage, the second part 442 of each first connecting element 44 extends upward and inclinedly from the first part 441. Therefore, when the telescoping element 34 moves out from the body 32, the connecting unit 40 can receive enough force to swing about the moving elements 60 to a second position P2 shown in FIG. 6; at this stage, the second end 52 of the backboard 50 is lifted up and the backboard 50 becomes inclined relative to the load-bearing elements 25 so that the user can be pushed up from aforesaid lying flat posture and sit with his back leaning against the backboard 50.

Besides, when the connecting unit 40 swings from the first position P1 to the second position P2, the moving elements 60 move away from the load-bearing elements 25 along the tracks 24 respectively so that the backboard 50, which swings up during the sawing movement of the connecting unit 40, also displaces away from the back of the user a little along with the connecting unit 40 and the moving elements 60. Therefore, the electric folding bed 10 can avoid the abdomen of the user from being pressed when the user sits up so as to avoid the user's uncomfort and injury.

It will be appreciated that the phrase “track” mentioned in the invention refers to any kind of track adapted for a moving element to move linearly thereon along the head-to-foot axis, not specially limited to the kind of track shown in the figures. For example, each track can be a slot penetrating the lengthwise beam of the base; in this case, each moving element can be a shaft inserted in the slot.

What is claimed is:

1. An electric folding bed, which is defined with an imaginary head-to-foot axis, comprising:
a base including a load-bearing element for supporting hips of a user, and at least a track extending along the head-to-foot axis of the electric folding bed;
a telescopic actuator including a body pivotally attached to the base, and a telescoping element linearly moveable relative to the body substantially along the head-to-foot axis of the electric folding bed;
a connecting unit and a backboard fastened to the connecting unit for the user to lean thereon, the backboard having a first end facing the load-bearing element and a second end opposite to the first end, the connecting unit being pivotally connected with the telescoping element in a way that the telescoping element drives the connecting unit to swing between a first position and a second position and the second end of the backboard is lifted up when the connecting unit swings from the first position to the second position;
at least a supporting element having a front end and a rear end located more adjacent to the first end of the backboard than the front end, the front end and the rear end of the supporting element being pivotally attached to the base and the connecting unit respectively; and
at least a moving element disposed to the track of the base and pivotally attached to the connecting unit in a way that the connecting unit swings about the moving element and drives the moving element to move along the track of the base;
the moving element being moved away from the load-bearing element when the connecting unit swings from the first position to the second position.

2. The electric folding bed as claimed in claim 1, comprising two said supporting elements and two said moving elements; wherein the base has two said tracks located by two sides of the telescopic actuator respectively; the moving elements are disposed to the tracks respectively; the connecting unit comprises a first connecting element pivotally connected with the telescoping element, and two second connecting elements pivotally connected with the moving elements respectively and pivotally connected with the supporting elements respectively.

3. The electric folding bed as claimed in claim 1, wherein the connecting unit comprises a curved first connecting element having a first part and a second part connected with the first part at an angle; the first part of the first connecting element is pivotally connected with the telescoping element; the second part of the first connecting element is located between the first part of the first connecting element and the backboard and extends upward from the first part of the first connecting element when the connecting unit is located at the first position.

4. The electric folding bed as claimed in claim 1, wherein the connecting unit comprises a second connecting element having a first connecting portion pivotally connected with the supporting element, and a second connecting portion pivotally connected with the moving element; the first connecting portion of the second connecting element is located between the second connecting portion of the second connecting element and the front end of the supporting element.
